(19) United States
(12) Patent Application Publication
(10) Pub. No.: US 2026/0177420 A1
(43) Pub. Date: Jun. 25, 2026

(54) ADAPTIVE ASSISTIVE DEVICE AND METHOD

(71) Applicant: Industrial Technology Research Institute, Hsinchu (TW)

(72) Inventors: Hung-Kai Chen, Hsinchu City (TW); Ming-Chieh Tsai, Hsinchu County (TW); Tsung-Hua Li, Hsinchu City (TW); YOONG KEE SEK, Hsinchu City (TW); Ching-Yu Huang, Taoyuan City (TW)

(73) Assignee: Industrial Technology Research Institute, Hsinchu (TW)

(21) Appl. No.: 19/178,792

(22) Filed: Apr. 14, 2025

Related U.S. Application Data
(60) Provisional application No. 63/737,806, filed on Dec. 23, 2024.

(30) Foreign Application Priority Data
Mar. 7, 2025 (TW) 114108527

(51) Int. Cl. G01H 17/00; G06F 3/01

(52) U.S. Cl. CPC G01H 17/00; G06F 3/011

(57) ABSTRACT

The adaptive assistive device and method provided by the disclosure can provide music or vibration to patients with Parkinson's disease to prompt the patient to walk with the rhythm without causing shuffling gait or freezing of gait. At the same time, the adaptive assistive device can also receive signal feedback from the patient's stepping to adjust the frequency of the output music or vibration. In this way, patients can receive personalized treatment. With immediate feedback, patients are less likely to fall and can improve their walking gait.

### CROSS-REFERENCE TO RELATED APPLICATION

This application claims the priority benefit of U.S. provisional application Ser. No. 63/737,806, filed on Dec. 23, 2024 and Taiwan application serial no. 114108527, filed on Mar. 7, 2025. The entirety of each of the above-mentioned patent applications is hereby incorporated by reference herein and made a part of this specification.

### TECHNICAL FIELD

The disclosure relates to an assistive device and method, and more particularly relates to an adaptive assistive device and method.

### BACKGROUND

The number of individuals with Parkinson's disease is increasing annually. As the disease progresses, the efficacy of medication in controlling the gait of the patient and balance gradually diminishes. Patients commonly exhibits shuffling gait during daily walking, and even experiences freezing of gait (FOG) phenomenon, consequently increasing the risk of falls and disability.

Current non-pharmacological treatment or control methods include stimulation through treadmill as a carrier in conjunction with external music, as well as visual guidance rehabilitation through laser light. However, the aforementioned methods all present privacy concerns, and the multitasking requirement (simultaneously using eyes to observe while using feet to step) often diminishes the therapeutic efficacy. Therefore, how to provide a device and method that can both maintain patient confidentiality and safely enhance treatment efficacy constitutes an important topic.

### SUMMARY

In view of this, an adaptive assistive device and method are provided in the disclosure. The adaptive assistive device and method assist a patient in walking by detecting gait signals and providing feedback according to the gait signals.

The adaptive assistive device disclosed in the disclosure includes a transceiver and a processor. The processor is coupled to the transceiver and is configured to perform the following operation. A first prompt signal is provided through the transceiver, in which the first prompt signal has a first frequency. A first sensing signal and a second sensing signal are obtained through the transceiver, in which the first sensing signal and the second sensing signal are ground reaction force or inertia sensing signal. In response to a difference between the first sensing signal and the second sensing signal being greater than a first threshold, a first warning signal is sent through the transceiver. A second prompt signal is sent through the transceiver according to the first sensing signal and the second sensing signal, in which the second prompt signal has a second frequency.

The adaptive assistive method disclosed in the disclosure includes the following operation. A first prompt signal is provided through the transceiver, in which the first prompt signal has a first frequency. A first sensing signal and a second sensing signal are obtained through the transceiver, in which the first sensing signal and the second sensing signal are ground reaction force or inertia sensing signal. In response to a difference between the first sensing signal and the second sensing signal being greater than a first threshold, a first warning signal is sent through the transceiver. A second prompt signal is sent through the transceiver according to the first sensing signal and the second sensing signal, in which the second prompt signal has a second frequency.

Based on the above, the adaptive assistive device and method provided by the disclosure can provide Parkinson's disease patients with music or vibration to prompt the patients to walk in rhythm, preventing the occurrence of shuffling gait or the freezing of gait phenomenon. At the same time, the adaptive assistive device can also receive signal feedback from the stepping of patients to adjust the frequency of the output music or vibration. In this way, patients can receive personalized treatment, and due to immediate feedback, they are less likely to be at risk of falling and can also improve their walking gait.

### BRIEF DESCRIPTION OF THE DRAWINGS

FIG. 1 is a schematic diagram of an adaptive assistive device of the disclosure.

FIG. 2 is a flowchart schematic diagram of the adaptive assistive method of the disclosure.

FIG. 3 is a diagram showing the system architecture of the adaptive assistance of the disclosure.

[ ] FIG. 4 is a flowchart of the adaptive patient assistance cycle of the disclosure.

FIG. 5 is a schematic diagram of the feedback-assisted patient of the disclosure.

FIG. 6 is a schematic diagram of gait data detection of the disclosure.

FIG. 7A is a data diagram of a user interaction index detected by an adaptive assistive device under a fixed beat of the disclosure.

FIG. 7B is a data diagram of the music rhythm under a fixed beat of the disclosure.

FIG. 7C is a data diagram of a user interaction index detected by an adaptive assistive device under an adaptive beat of the disclosure.

FIG. 7D is a data graph of music rhythm under the adaptive beat of the disclosure.

### DETAILED DESCRIPTION OF DISCLOSED EMBODIMENTS

References of the exemplary embodiments of the disclosure are to be made in detail. Examples of the exemplary embodiments are illustrated in the accompanying drawings. Terms “first,” “second” and the like mentioned in the full text (including the scope of the patent application) of the description of this application are used only to name the elements or to distinguish different embodiments or scopes and are not intended to limit the upper or lower limit of the number of the elements, nor is it intended to limit the order of the elements. In addition, wherever possible, elements/components with the same reference numerals in the drawings and embodiments represent the same or similar parts.

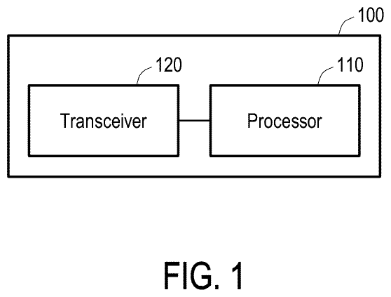

FIG. 1 is a schematic diagram of an adaptive assistive device of the disclosure. The adaptive assistive device 100 may include a processor 110 and a transceiver 120.

In embodiments of the disclosure, the processor is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar elements, or a combination of the elements thereof. In the adaptive assistive device 100, the processor 110 may be coupled to the transceiver 120.

The transceiver 120 transmits and receives signals in a wireless or wired manner. The transceiver 120 may also perform operations such as low noise amplification, impedance matching, frequency mixing, up or down frequency conversion, filtering, amplification, and the like. In the embodiments of the disclosure, the transceiver 120 may be a device that can play music. The transceiver 120 may also be a belt, bracelet, or anklet that can vibrate to prompt the user. The transceiver 120 may also be an integrated earphone capable of playing music and vibrating, such as utilizing AirPods (Apple wireless earphones) as a carrier for receiving and transmitting signals. In addition, any device that can emit vibration or music falls within the scope of the transceiver 120 of the disclosure.

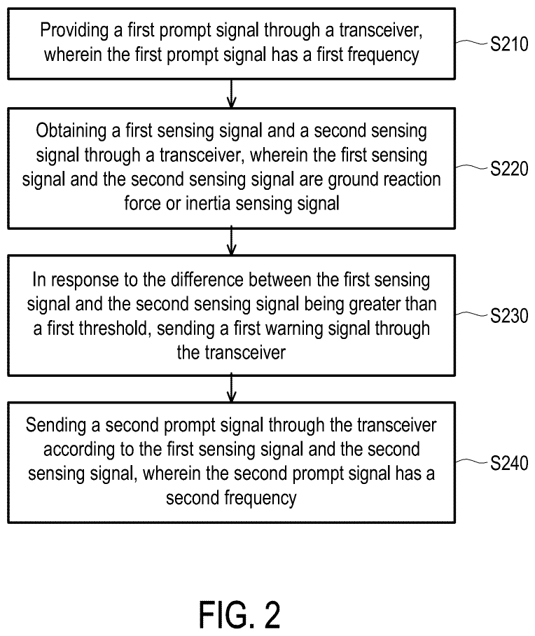

Referring to FIG. 2, FIG. 2 is a flowchart schematic diagram of the adaptive assistive method of the disclosure, which can be implemented by the processor 110 of the disclosure. In process S210, the processor 110 may provide a first prompt signal through the transceiver 120, in which the first prompt signal has a first frequency. In process S220, the processor 110 may obtain a first sensing signal and a second sensing signal through the transceiver 120, in which the first sensing signal and the second sensing signal are ground reaction force or inertia sensing signal. In process S230, the processor 110 may send a first warning signal through the transceiver 120 in response to the difference between the first sensing signal and the second sensing signal being greater than a first threshold. In process S240, the processor 110 may send a second prompt signal through the transceiver 120 according to the first sensing signal and the second sensing signal, in which the second prompt signal has a second frequency.

In one embodiment of the disclosure, the transceiver 120 of the adaptive assistive device 100 may further include a sensor. Sensors exist in physical form and can detect or sense signals, physical conditions (e.g., light, heat, humidity, gravity) or chemical compositions (e.g., smoke), and transmit the detected information to other devices. In the embodiment of the disclosure, the sensor may be a ground reaction force sensor for detecting ground reaction force. In other embodiments of the disclosure, the sensor may also exist independently of the transceiver 120.

In one embodiment of the disclosure, the adaptive assistive device 100 may include AirPods with a signal transceiver function as the transceiver 120, and the processor 110 may send an audio signal or a vibration signal as a prompt signal through the AirPods. Specifically, the processor 110 may emit music with a first frequency as a first prompt signal through the AirPods. Alternatively, the processor 110 may emit vibration with a first frequency as a first prompt signal through the AirPods to guide the user to walk according to the first frequency. In an extended embodiment of the disclosure, the processor 110 may also emit music having a first frequency through the AirPods, and simultaneously emit vibration through the AirPods on the beat of the music, serving as an enhanced first prompt signal and guiding the user to synchronize their walking steps with the beats.

As mentioned above, the processor 110 can receive various sensing signals through the AirPods. Specifically, the inertial measurement unit (IMU) can sense physical quantity related information such as acceleration, speed and distance when the user is walking. Therefore, the processor 110 can receive the sensing signal when the user is walking through the inertial measurement unit built into the AirPods. In other embodiments of the disclosure, the adaptive assistive device 100 may further include a sensor disposed on the smart insole. When the user walks, the sensor may receive a ground reaction force signal of the user and transmit the ground reaction force signal to the AirPods for reception via wireless transmission signals.

Continuing from the previous paragraphs, the processor 110 can calculate the received sensing signals and the sent prompt signals, and the processor 110 determines whether the user's walking can keep up with the prompt signals. The processor 110 can thereby send a warning signal through the AirPods when it determines that the user may be at risk while walking (e.g., falling). Alternatively, the processor 110 can send prompt signals with different frequencies through the AirPods as training when it determines that the user can walk well. The processor 110 adjusts the details of the signal sent through the AirPods according to the sensing signal and the prompt signal, which will be described in the following paragraphs.

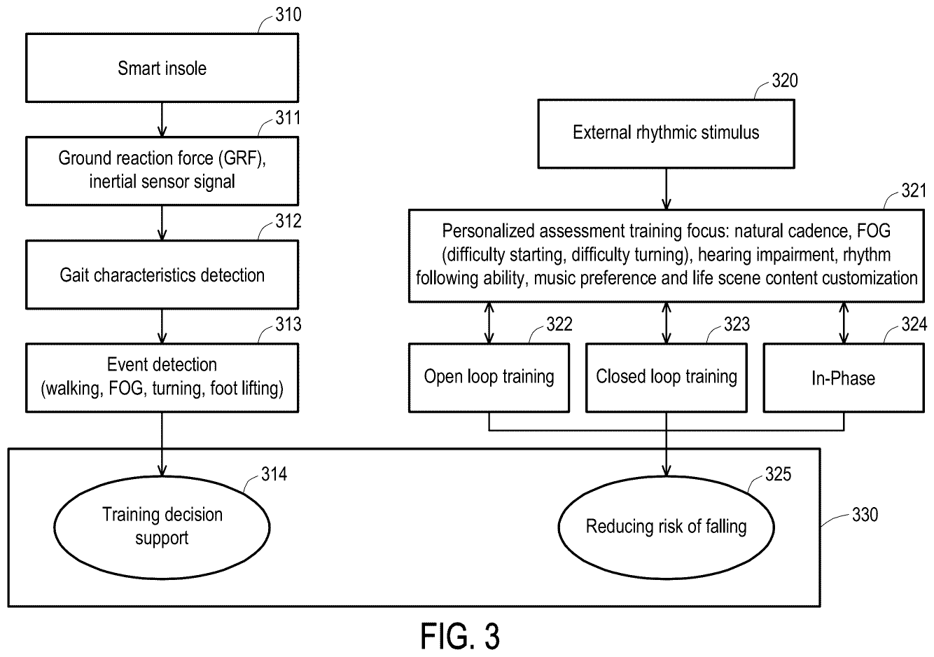

Referring to FIG. 3, FIG. 3 is a diagram showing the system architecture of the adaptive assistance of the disclosure. As shown in FIG. 3, the adaptive assistive system may include two primary components: a smart insole 310 and an external rhythmic stimulus 320. The system uses signal reception and signal release as a means of training Parkinson's disease patients to walk, thereby reducing and preventing the risk of falls among Parkinson's disease patients. In the embodiment of the disclosure, the processor 110 can receive the ground reaction force (GRF), inertial sensing signal 311 of the user through the smart insole 310, and the processor 110 performs gait characteristics detection 312 accordingly. The processor 110 may further determine event detection (walking, FOG, turning, foot lifting) 313 according to the detected gait. Finally, the processor 110 can perform training decision support 314 based on the received signal, that is, the processor 110 can determine the event state of the user according to the received ground reaction force signal, and the processor 110 can train the user using the training method corresponding to the event state.

Continuing from the previous paragraphs, in the embodiment of the disclosure, the processor 110 can train the user through an external rhythmic stimulus 320. For example, the processor 110 can perform personalized assessment training focus on the user: natural cadence, FOG (difficulty starting, difficulty turning), hearing impairment, rhythm following ability, music preference and life scene content customization 321. The processor 110 can also perform personalized open loop training 322, closed loop training 323 and In-Phase 324 training on the user. The processor 110 may also repeat the personalized assessment according to the training results of the aforementioned open loop training 322, closed loop training 323, and In-Phase 324 training, and repeatedly provide a new round of open loop training 322, closed loop training 323, and In-Phase 324 training according to the training results of the user. In this way, the processor 110 can eventually enable the user to achieve the effect 330 of reducing the risk of falling 325. This disclosure will further describe the smart insole and external rhythmic stimulus in subsequent paragraphs.

Referring to FIG. 4, FIG. 4 is a flowchart of the adaptive patient assistance cycle of the disclosure. First, the processor 110 may receive the ground reaction force/inertia sensing signal 410 through the smart insole. Specifically, at least one sensor may be disposed on the smart insole, and the sensor may sense the sensing signal of the pressure of each contact point when the foot of the user steps down and contacts the ground. In other embodiments of the disclosure, an inertial sensor may be disposed on the smart insole, whereby the processor 110 may detect information of physical quantity related signals such as acceleration, velocity, and distance of foot movement states through an inertial sensor.

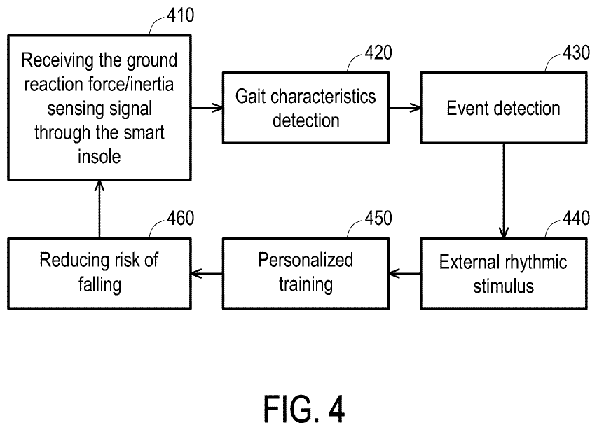

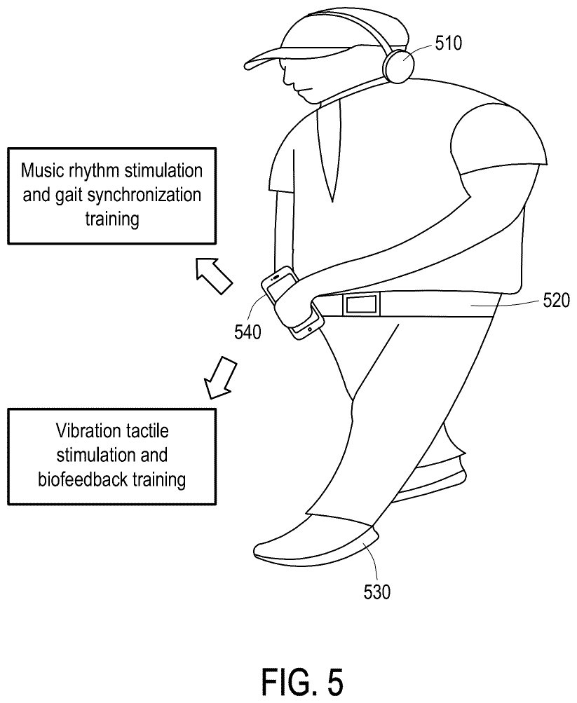

Please continue to refer to to FIG. 4, after the processor 110 obtains the sensing signal through the smart insole, the processor 110 may perform gait characteristics detection 420. Specifically, the processor 110 may analyze the obtained sensing signals of contact point pressure or sensing signals of foot movement state, whereby the processor 110 obtains the gait characteristics of the patient during stepping. Furthermore, the processor 110 may perform event detection 430 according to the gait characteristics, whereby the processor 110 may determine the state of the patient, such as normal walking, shuffling gait, or freezing of gait. How to analyze the aforementioned signals to obtain gait characteristics will be described in detail in the subsequent paragraphs and FIG. 5.

Continuing from the previous paragraphs, the processor 110 may further send an external rhythmic stimulus 440 to the patient according to the gait characteristics and the detected event. Specifically, the processor 110 may provide stimulation in a timely manner according to whether the gait characteristics index of the patient is abnormal, or the processor 110 may provide stimulation according to the state of the patient, such as normal walking, shuffling gait, or freezing of gait. When the patient is in a normal walking state, the processor 110 can adjust the frequency of the music or the frequency of the belt vibration to the first frequency according to the first frequency of the normal walking of the patient, so as to prompt the patient to continue walking at the first frequency. When the patient is in a state of shuffling gait or freezing of gait, the processor 110 can slow down the music or the frequency of the vibration belt, or the processor 110 can enhance or intensify the prompted music or vibration through the transceiver 120 on the beat as an external rhythmic stimulus.

In other embodiments of the disclosure, the adaptive assistive device 100 may directly apply the external rhythmic stimulus 440 on the patient without event detection. For example, in the rehabilitation treatment of a Parkinson's disease patient, the adaptive assistive device 100 directly performs external rhythmic stimulation at a fixed time point to carry out the treatment.

Please continue to refer to to FIG. 4, the processor 110 can perform personalized training 450 on the user through external rhythmic stimulation. Specifically, since the recovery conditions of different patients during the course of the disease vary from person to person, giving different patients the same treatment course is obviously not enough to meet the circumstances of different patients. For example, if the first patient recovers well and is able to step on the beats emitted by the transceiver 120 after being applied with the external rhythmic stimulus 440 from the processor 110, the processor 110 may increase the frequency of the music or vibration released by the external rhythmic stimulus 440 to train the first patient to train at an increased frequency. For another example, if the second patient is unable to step on the beat, the processor 110 may reduce the frequency of the music or vibration, and the processor 110 trains the second patient at the reduced frequency.

Continuing from the previous paragraphs, since the processor 110 can adjust the frequency of the corresponding music or vibration according to the walking condition of the user, when the patient is receiving a frequency that is more suitable for their own condition, the patient walks according to the frequency, which can reduce the risk of falling 460.

In the embodiment of the disclosure, the initial signal of the external rhythmic stimulation sent by the processor 110 through the transceiver 120 is the first prompt signal, and the signal adjusted by the processor 110 according to the walking condition of the patient is the second prompt signal. In the embodiment of the disclosure, the first prompt signal and the second prompt signal may be vibration signals or music signals.

FIG. 5 is a schematic diagram of the feedback-assisted patient of the disclosure. In FIG. 5, the processor 110 may release a prompt signal through earphones 510 or a vibration belt 520 to provide a frequency for the user to follow. At the same time, the processor 110 can also receive the data of the ground reaction force when the user user steps on a ground reaction force insole 530. The processor 110 adjusts the frequency of the prompt signal released by the earphones 510 or the vibration belt 520 according to the ground reaction force data. In addition, the processor 110 can also release a prompt signal through the mobile phone 540 to provide a frequency for the user to follow. For example, the processor 110 can play music rhythm through the mobile phone 540 to stimulate the user for synchronizing training with the gait of the user. The processor 110 may also send vibration tactile stimulus through the mobile phone 540 to train the biofeedback of the user. In other embodiments of the disclosure, the processor 110 may also provide a frequency for the user to follow via any transceiver 120 capable of releasing a prompt signal.

In the embodiment of the disclosure, the closed loop training 323 may specifically be as follows: the processor 110 may determine an interaction index according to an initial prompt signal from the earphones 510, the vibrating belt 520 or the mobile phone 530 and a plurality of ground reaction force sensing signals received, and adjust the adjusted prompt signal from the earphones 510, the vibrating belt 520 or the mobile phone 530 according to the interaction index.

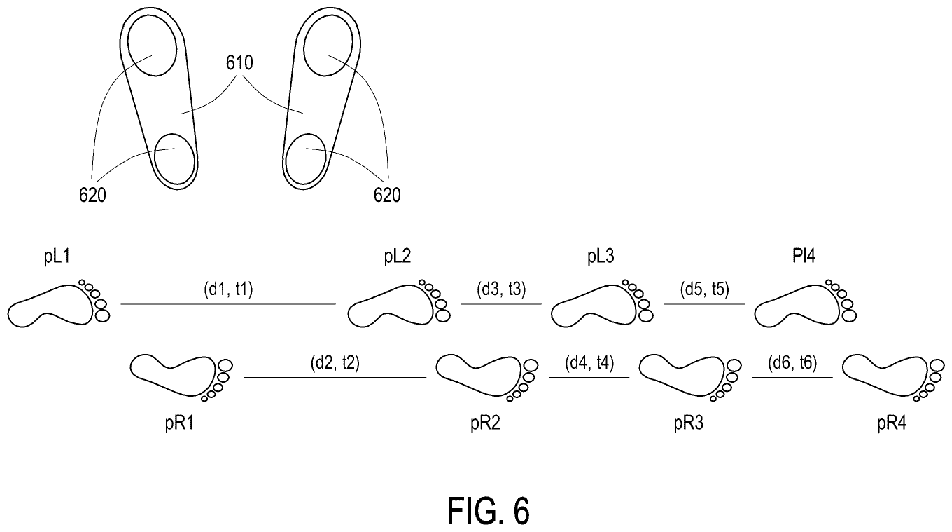

Specifically, referring to FIG. 6, FIG. 6 is a schematic diagram of gait data detection of the disclosure. The processor 110 may receive the sensed ground reaction force signal 620 of the user through the ground reaction force insole 610. Specifically, apart from flat feet, a normal foot includes three main arches (medial longitudinal arch, lateral longitudinal arch, and transverse arch), which enables the foot, when stepping on the ground, to primarily distribute pressure to the toes and heel, as shown by the ground reaction force signal 620 in FIG. 6.

Please continue to refer to FIG. 6, the processor 110 can determine the stepping positions of the left foot and the right foot of the user according to the ground reaction force signal 620. Specifically, the processor 110 may record the left foot position points pL1, L2, pL3, pL4 and the right foot position points pR1, pR2, pR3, pR4 as shown in FIG. 6 according to the data of the collected ground reaction force signal 620. The processor 110 may also calculate the distance d1 and the duration t1 according to the left foot position point pL1 and the left foot position point pL2. The processor 110 may calculate the distance d1 according to the difference between the left foot position point pL1 and the left foot position point pL2, and the processor 110 may calculate the duration t1 according to the difference between the initial dwell time of the left foot position point pL1 and the initial dwell time of the left foot position point pL2. The processor 110 also calculates the distances d1, d2, d3, d4, d5, d6 and the durations t1, t2, t3, t4, 5, t6 in FIG. 6 in the above manner.

In the embodiment of the disclosure, the processor 110 can calculate the first dwell time of the first sensing signal (e.g., the first step taken by the left foot) and the second dwell time of the second sensing signal (e.g., the first step taken by the right foot), and calculate the difference according to the first dwell time and the second dwell time.

In the embodiment of the disclosure, the processor 110 may also receive a third sensing signal (e.g., the second step taken by the left foot) and a fourth sensing signal (e.g., the second step taken by the right foot) through the transceiver 120. The source of the first sensing signal and the source of the third sensing signal are the first source, and the source of the second sensing signal and the source of the fourth sensing signal are the second source. The first sensing signal includes first position information, the second sensing signal includes second position information, the third sensing signal includes third position information, and the fourth sensing signal includes fourth position information. The processor 110 may calculate a first distance according to the first position information and the third position information, calculate a second distance according to the second position information and the fourth position information, and calculate a difference according to the first distance and the second distance.

For details, please refer to the calculation process below. The distance and duration are sorted as shown in Table 1 below:

TABLE 1
Distance and duration table

| | Step s1 | Steps2 | Step s3 | Step s4 | Step s5 | Step s6 |
|---|---|---|---|---|---|---|
| Distance (m) | 0.8 | 1 | 1.3 | 1.1 | 0.9 | 1.2 |
| Duration (sec) | 0.9 | 1 | 1.1 | 1 | 1 | 1.3 |

In the embodiment of the disclosure, the processor 110 may further calculate the coefficient of variation (CV) of the distance and the duration according to Table 1. The calculation formula is as follows:

$$dCV = \frac{SD ( d 1 to d 6 )}{Mean ( d 1 to d 6 )} \qquad ( Formula 1 )$$

$$tCV = \frac{SD ( t 1 to t 6 )}{Mean ( t 1 to t 6 )} \qquad ( Formula 2 )$$

In Formula 1, dCV is the coefficient of variation of the distance, SD(d1 to d6) is the standard deviation of d1, d2, d3, d4, d5, and d6, and Mean (d1 to d6) is the mean of d1, d2, d3, d4, d5, and d6. In Formula 2, tCV is the coefficient of variation of the duration, SD(t1 to t6) is the standard deviation of t1, t2, t3, t4, 5, and t6, and Mean (t1 to t6) is the mean of t1, t2, t3, t4, t5, and t6.

When a normal person walks, the distance and stepping time of each step are stable and present similar values, so dCV and tCV are close to 0 when a normal person walks. In contrast, Parkinson's disease patients may have different step distances and dwell times for their left and right feet, resulting in larger dCV and tCV than normal people. Therefore, if the step distance and the dwell time of the left and right feet are different and greater than a preset threshold, the dCV or tCV will also be greater than a threshold value, indicating a potential freezing of gait in the walking pattern of a Parkinson's disease patient. Consequently, the processor 110 may send a warning signal.

In the embodiment of the disclosure, the processor 110 may further calculate a phase coordination index (PCI) according to Table 1. Specifically, Parkinson's disease patients often have different stride lengths between their left and right feet when walking. After the patient undergoes training or treatment, the stride length between the patient's left and right feet may approach equivalence. Therefore, the processor 110 can determine the effect of the treatment or training of the patient by calculating the phase coordination index. It is calculated as follows:

$$ψ x = 360 * \frac{pRx - pLx}{pL ( x + 1 ) - pLx} \qquad ( Formula 3 )$$

$$PCI = 100 * ( \frac{stdev ( ψ )}{mean ( ψ )} + \frac{mean ( \vert ψ - 180 \vert )}{180} ) \qquad ( Formula 4 )$$

In the formulas, ψx is the phase of x, pRx represents the position of the x^{th} point of the right foot, pLx represents the position of the x^{th} point of the left foot, and pLx represents the position of the x+1^{th} point of the left foot. PCI is the phase coordination index. stdev(ψ) is the standard deviation of all ψ, mean(ψ) is the mean of all ψ, and |ψ−180| is the absolute value of ψx minus 180. Taking FIG. 6 as an example, ψ1 is calculated by subtracting pL1 from pR1 and pL1 from pL2, and then dividing the two and multiplying by 360. Then, as shown in Formula 4, the standard deviation, the mean, and the mean of the absolute value of each ψ minus 180 are calculated for all the calculated ψs, thereby calculating the PCI. When a normal person walks, the stride lengths of the left and right feet are similar, and the step position of the left and right feet is at the center relative to the front and back positions of the other foot. Therefore, the standard deviation of ψ approaches 0, and ψ minus 180 also approaches 0, such that PCI also approach 0, indicating a good gait coordination. On the other hand, Parkinson's disease patients have irregular stride lengths and step positions of their left and right feet, so their PCI values are larger. Their gait coordination is worse than that of normal people.

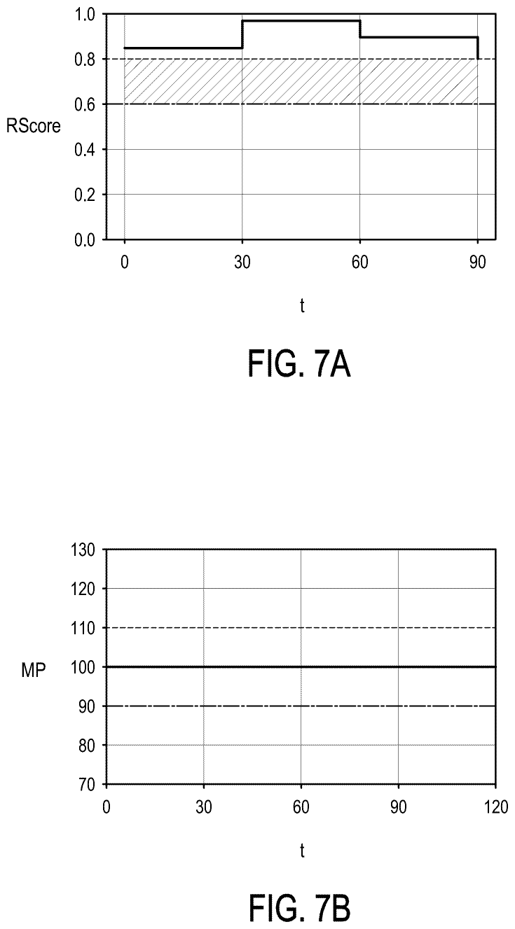

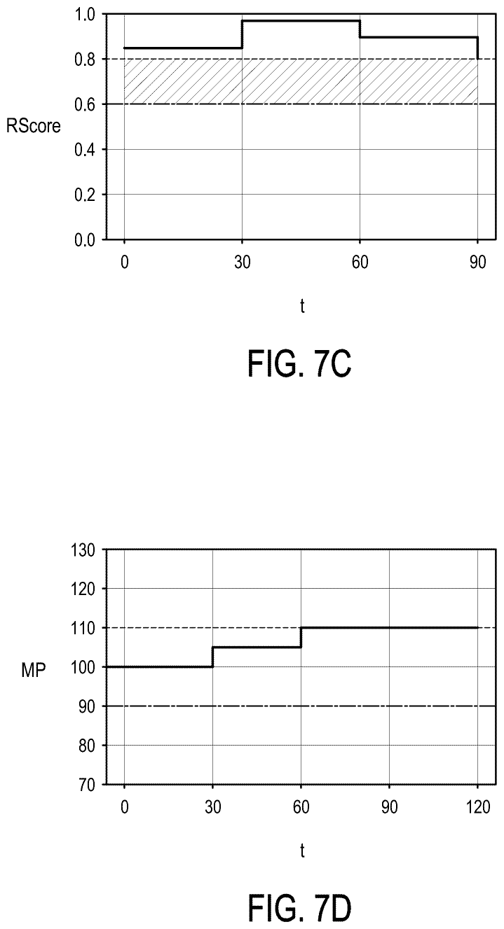

Referring to FIG. 7A, FIG. 7B, FIG. 7C, and FIG. 7D, in FIG. 7A and FIG. 7C, the unit of the horizontal axis is time (t), and the unit of the vertical axis is the interaction index (RScore). In FIG. 7B and FIG. 7D, the unit of the horizontal axis is time (t), and the unit of the vertical axis is music speed (MP). FIG. 7A is a data diagram of a user interaction index detected by an adaptive assistive device under a fixed beat of the disclosure, and FIG. 7B is a data diagram of the music rhythm under a fixed beat of the disclosure. Specifically, in the open loop training 322 under a fixed beat, the patient's interactive index following the music does not affect the music speed in the current training. The processor 110 may record the interaction between the patient's stepping and the music frequency to obtain an interaction index, and the processor 110 may adjust the music frequency according to the interaction index during the next training.

FIG. 7C is a data diagram of a user interaction index detected by an adaptive assistive device under an adaptive beat of the disclosure, and FIG. 7D is a data graph of music rhythm under the adaptive beat of the disclosure. Specifically, in the closed loop training 323 under an adaptive beat, the patient's interactive index following the music can affect the music speed in the current training. The processor 110 may record the interaction between the patient's stepping and the music frequency to obtain an interaction index, and the processor 110 may adjust the music speed according to the interaction index at the next stage of the current training. Taking FIG. 7C and FIG. 7D as examples, since the interaction index from 0 to 30 seconds is greater than 0.8, the music speed from 30 seconds to 60 seconds in the next stage is faster than the music speed from 0 to 30 seconds. The aforementioned stage may be, for example, 30 seconds per stage, and the processor 110 may assess the interaction index within 30 seconds to determine whether to adjust the frequency of the music in the next stage.

In the embodiment of the disclosure, in order to prevent an infinite increase or decrease in the frequency of music during a single training session, the processor 110 may set an upper limit and a lower limit for the adjusted music speed. For example, the upper limit of the adjusted music speed is 110% of the initial music speed, and the lower limit of the adjusted music speed is 90% of the initial music speed.

In the embodiment of the disclosure, the aforementioned interaction index can be calculated according to the correspondence between the music beats and the stepping time points of the patient. Table 2 below shows the data of the music beats and the stepping time points of the patients.

TABLE 2
Music beats and stepping time points of patients

| n | 1 | 2 | 3 | 4 | 5 | 6 | 7 | 8 | 9 |
|---|---|---|---|---|---|---|---|---|---|
| Music | 1 | 2 | 3 | 4 | 5 | 6 | 7 | 8 | 9 |
| beat Bn | | | | | | | | | |
| Patient | 1.811 | 2.356 | 3.495 | 4.663 | 5.64 | 6.65 | 7.601 | 8.574 | 9.596 |
| stepping | | | | | | | | | |
| time Tn | | | | | | | | | |

The processor 110 may first calculate the phase Un according to the values in Table 2, for example, by using Formula 5:

$$ψ n = 360 * \frac{Tn - Bn}{B ( n + 1 ) - Bn} \qquad ( Formula 5 )$$

The obtained phase ψn can be converted into the coordinates of a unit circle, such as the following Formula 6:

$${e}^{iψ} = cos ψ + i sin ψ \qquad ( Formula 6 )$$

The following table is obtained:

| n | 1 | 2 | 3 | 4 | 5 | 6 | 7 | 8 | 9 |
|---|---|---|---|---|---|---|---|---|---|
| ψn | 291.96 | 128.16 | 178.2 | 238.68 | 230.4 | 234 | 216.36 | 206.64 | 214.56 |
| cos ψ | 0.3739 | −0.6178 | −0.9995 | −0.5198 | −0.6374 | −0.5877 | −0.8086 | −0.8938 | −0.8235 |
| sinψ | −0.9274 | 0.7862 | 0.0314 | −0.8542 | −0.7705 | −0.8090 | −0.5928 | −0.4483 | −0.5672 |

Then, the interaction index is calculated based on the values of cos ψ and sin ψ.

In the embodiment of the disclosure, when the interaction index is less than 0.6, the adjusted music/vibration frequency is 0.95 times the music/vibration frequency before adjustment. When the interaction index is greater than 0.8, the adjusted music/vibration frequency is 1.05 times the music/vibration frequency before adjustment. When the interaction index is not greater than 0.8 and not less than 0.6, the adjusted music/vibration frequency is maintained equal to the music/vibration frequency before adjustment.

In an embodiment of the disclosure, the adjusted music/vibration frequency is not greater than 1.1 times the initial music/vibration frequency, and the adjusted music/vibration frequency is not less than 0.9 times the initial music/vibration frequency. More specifically, since the music/vibration frequency as shown in FIG. 6C and FIG. 6D can be adjusted according to the interaction index, in order to prevent an infinite increase or decrease in the music/vibration frequency, the embodiments of the disclosure can set upper and lower limits of the final adjusted music/vibration frequency.

In an embodiment of the disclosure, in the open loop training 322 under a fixed music beat, the processor 110 sends a first prompt signal through the transceiver 120 in a first cycle, and the processor 110 receives multiple first cycle sensing signals in the first cycle through, for example, a ground reaction force insole. Next, the processor 110 calculates the interaction index according to the first cycle sensing signals to adjust the music/vibration frequency in the second cycle. That is, although the frequency of music/vibration remains fixed within the duration of the same piece of music under fixed beat training, there are usually 6 cycles in one treatment course, so the processor 110 can adjust the music/vibration frequency during the next cycle, that is, the next piece of music.

In another embodiment of the disclosure, In-Phase 324 may specifically be: the processor 110 may adjust the music/vibration frequency outputted subsequently according to the received sensing signal and the music/vibration frequency that has been sent. Specifically, each time the patient takes a step, the processor 110 can perform real-time interactive index calculation according to the sensing signal of the step and the music/vibration frequency sent by the processor 110 through the transceiver 120. Therefore, the processor 110 can adjust the music/vibration frequency outputted subsequently according to the interaction index.

In other embodiments of the disclosure, the processor 110 may also predict a sensing signal that may be received next based on the received sensing signal. Specifically, the processor 110 may determine that the patient is under the condition of shuffling gait or freezing of gait based on the received sensing signal and further predict that the patient may be about to fall, and the processor 110 predicts the potential reception of a fall signal. At this time, the processor 110 may send a warning signal or adjust the output signal through the transceiver 120 to prevent the patient from falling.

An adaptive assistive method is also provided in this disclosure. The adaptive assistive method can be executed by the processor 110 of the adaptive assistive device. The process and implementation methods are as described in the previous paragraphs and are not repeated herein.

To sum up, the adaptive assistive device and method provided by the disclosure can provide Parkinson's disease patients with music or vibration to prompt the patients to walk in rhythm, preventing the occurrence of shuffling gait or the freezing of gait phenomenon. At the same time, the adaptive assistive device can also receive signal feedback from the stepping of patients to adjust the frequency of the output music or vibration. In this way, patients can receive personalized treatment, and due to immediate feedback, they are less likely to be at risk of falling and can also improve their walking gait.

What is claimed is:

1. An adaptive assistive device, comprising:
a transceiver; and
a processor, coupled to the transceiver and configured to:
provide a first prompt signal through the transceiver, wherein the first prompt signal has a first frequency;
obtain a first sensing signal and a second sensing signal through the transceiver, wherein the first sensing signal and the second sensing signal are ground reaction force or inertia sensing signal;
in response to a difference between the first sensing signal and the second sensing signal being greater than a first threshold, send a first warning signal through the transceiver; and
send a second prompt signal through the transceiver according to the first sensing signal and the second sensing signal, wherein the second prompt signal has a second frequency.

2. The adaptive assistive device according to claim 1, wherein the first prompt signal and the second prompt signal are vibration signals or music signals.

3. The adaptive assistive device according to claim 1, wherein the processor is further configured to:
determine an interactive index according to the first prompt signal, the first sensing signal, and the second sensing signal; and
adjust the second prompt signal according to the interactive index.

4. The adaptive assistive device according to claim 3, wherein the processor is further configured to:
adjust the second frequency to 0.95 times the first frequency when the interaction index is less than 0.6;
adjust the second frequency to 1.05 times the first frequency when the interaction index is greater than 0.8; and
maintain the second frequency equal to the first frequency when the interaction index is not greater than 0.8 and not less than 0.6.

5. The adaptive assistive device according to claim 3, wherein the processor is further configured to:
maintain the second frequency to be no greater than 1.1 times the first frequency; and
maintain the second frequency to be no less than 0.9 times the first frequency.

6. The adaptive assistive device according to claim 1, wherein the processor is further configured to:
send the first prompt signal in a first cycle through the transceiver;
receive a plurality of first cycle sensing signals in the first cycle through the transceiver;
calculate an interaction index according to the first cycle sensing signals; and
send the second prompt signal in a second cycle through the transceiver according to the interactive index.

7. The adaptive assistive device according to claim 1, wherein the processor is further configured to:
obtain a third sensing signal through the transceiver;
calculate a third prompt signal according to the third sensing signal and the second prompt signal; and
send the third prompt signal through the transceiver.

8. The adaptive assistive device according to claim 1, wherein the processor is further configured to:
predict a predicted sensing signal according to the first sensing signal and the second sensing signal, wherein the predicted sensing signal is a fourth sensing signal predicted by the processor to be obtained through the transceiver; and
adjust the second prompt signal according to the predicted sensing signal.

9. The adaptive assistive device according to claim 1, wherein the processor is further configured to:
calculate a first dwell time of the first sensing signal and a second dwell time of the second sensing signal; and
calculate the difference according to the first dwell time and the second dwell time.

10. The adaptive assistive device according to claim 1, wherein the processor is further configured to:
receive a third sensing signal and a fourth sensing signal by the transceiver, wherein a source of the first sensing signal and a source of the third sensing signal are a first source, and a source of the second sensing signal and a source of the fourth sensing signal are a second source, wherein the first sensing signal comprises a first position information, the second sensing signal comprises a second position information, the third sensing signal comprises a third position information, and the fourth sensing signal comprises a fourth position information;
calculate a first distance according to the first position information and the third position information, and calculate a second distance according to the second position information and the fourth position information; and
calculate the difference according to the first distance and the second distance.

11. An adaptive assistive method, comprising:
providing a first prompt signal through a transceiver, wherein the first prompt signal has a first frequency;
obtaining a first sensing signal and a second sensing signal through the transceiver, wherein the first sensing signal and the second sensing signal are ground reaction force or inertia sensing signal;
in response to a difference between the first sensing signal and the second sensing signal being greater than a first threshold, sending a first warning signal through the transceiver; and
sending a second prompt signal through the transceiver according to the first sensing signal and the second sensing signal, wherein the second prompt signal has a second frequency.

12. The adaptive assistive method according to claim 11, wherein the first prompt signal and the second prompt signal are vibration signals or music signals.

13. The adaptive assistive method according to claim 11, further comprising:
determining an interactive index according to the first prompt signal, the first sensing signal, and the second sensing signal; and
adjusting the second prompt signal according to the interactive index.

14. The adaptive assistive method according to claim 13, further comprising:
adjusting the second frequency to 0.95 times the first frequency when the interaction index is less than 0.6;
adjusting the second frequency to 1.05 times the first frequency when the interaction index is greater than 0.8; and
maintaining the second frequency equal to the first frequency when the interaction index is not greater than 0.8 and not less than 0.6.

15. The adaptive assistive method according to claim 13, further comprising:
maintaining the second frequency to be no greater than 1.1 times the first frequency; and
maintaining the second frequency to be no less than 0.9 times the first frequency.

16. The adaptive assistive method according to claim 11, further comprising:
sending the first prompt signal in a first cycle through the transceiver;
receiving a plurality of first cycle sensing signals in the first cycle through the transceiver;
calculating an interaction index according to the first cycle sensing signals; and
sending the second prompt signal in a second cycle through the transceiver according to the interactive index.

17. The adaptive assistive method according to claim 11, further comprising:
obtaining a third sensing signal through the transceiver;
calculating a third prompt signal according to the third sensing signal and the second prompt signal; and
sending the third prompt signal through the transceiver.

18. The adaptive assistive method according to claim 11, further comprising:
predicting a predicted sensing signal according to the first sensing signal and the second sensing signal, wherein the predicted sensing signal is a fourth sensing signal predicted to be obtained through the transceiver; and
adjusting the second prompt signal according to the predicted sensing signal.

19. The adaptive assistive method according to claim 11, further comprising:
calculating a first dwell time of the first sensing signal and a second dwell time of the second sensing signal; and
calculating the difference according to the first dwell time and the second dwell time.

20. The adaptive assistive method according to claim 11, further comprising:
receiving a third sensing signal and a fourth sensing signal by the transceiver, wherein a source of the first sensing signal and a source of the third sensing signal are a first source, and a source of the second sensing signal and a source of the fourth sensing signal are a second source, wherein the first sensing signal comprises a first position information, the second sensing signal comprises a second position information, the third sensing signal comprises a third position information, and the fourth sensing signal comprises a fourth position information;
calculating a first distance according to the first position information and the third position information, and calculating a second distance according to the second position information and the fourth position information; and
calculating the difference according to the first distance and the second distance.
